(19) United States
(12) Patent Application Publication
(10) Pub. No.: US 2025/0340700 A1
(43) Pub. Date: Nov. 6, 2025

(54) HIGH FLOW, DUAL-TERMINATED POLYAMIDE POLYMERS

(71) Applicant: AdvanSix Resins & Chemicals LLC, Parsippany, NJ (US)

(72) Inventors: Yuan-Ping R. Ting, Plainsboro, NJ (US); Veera Nelliappan, Richmond, VA (US); David J. Loy, Richmond, VA (US); John V. Facinelli, Morristown, NJ (US); Gary Martin, Piscataway, NJ (US)

(21) Appl. No.: 18/280,212

(22) PCT Filed: Mar. 3, 2022
(86) PCT No.: PCT/US2022/018657

§ 371 Date: Sep. 2, 2023

Related U.S. Application Data
(60) Provisional application No. 63/156,078, filed on Mar. 3, 2021.

(51) Int. Cl. C08G 69/22; C08G 69/16; C08K 7/14

(52) U.S. Cl. CPC C08G 69/22; C08G 69/16; C08K 7/14

(57) ABSTRACT

Polyamides terminated at the amine end group, the carboxyl end group, or both the amine and carboxyl end groups. Specifically, the present disclosure relates to terminated polyamide polymers having a weight average molecular weight (Mw) from 22,000 Da to 56,000 Da and a formic acid viscosity (FAV) of less than 45.

### CROSS-REFERENCE TO RELATED APPLICATION

This application claims priority under 35 U.S.C. 119 (e) to Provisional Application No. 63/156,078, filed on Mar. 3, 2021, which is herein incorporated by reference in its entirety.

### FIELD

The present invention relates to a method for producing high flow, dual-terminated polyamide polymers and, in particular, for producing high flow, dual-terminated polyamide polymers with a narrow molecular weight distribution.

### BACKGROUND

Typical polyamide polymers, such as polycaprolactam or polyamide 6 (PA 6), are polymerized with mono-termination using an amine, which reacts with, and thereby terminates, the carboxyl end group or terminus of the polymer. Mono-termination may also be accomplished using an acid, which reacts with, and thereby terminates, the amine end group or terminus of the polymer. Dual-terminated polymers may be synthesized by including both an amine and an acid terminator. A decrease in melt flow index (MFI) is usually observed in dual-terminated polymers in comparison to unterminated polymers, leading to a decrease in processability.

Mono-terminated and dual-terminated polymers with improved physical characteristics are desired.

### SUMMARY

The present disclosure provides polyamide polymers that may be mono-terminated at one of their amino or carboxyl end groups or, alternatively, may be dual-terminated at both the amino and the carboxyl end-groups, referred to herein as dual-terminated polyamides. Specifically, the present disclosure provides a terminated polyamide, having a weight average molecular weight (Mw) from 22,000 Da to 56,000 Da and a formic acid viscosity (FAV) of less than 45. Low viscosity permits glass-filled compounding of the polyamides without sacrificing processability or significantly increasing viscosity after compounding.

The present disclosure also provides a process of synthesizing a terminated polyamide, including hydrolyzing a lactam to provide monomers having an amine end group and a carboxyl end group; polycondensing the monomers at a temperature of 230° C. to 270° C. to provide polyamide polymers having an amine end group and a carboxyl group; and terminating the polyamide by reaction with at least one chain terminator to provide a terminated polyamide with a weight average molecular weight (Mw) of 22,000 Da to 56,000 Da. Moreover, the process may be carried out in such a manner to provide a polyamide having a ratio of the weight average molecular weight (Mw) of the polyamide to the number average molecular weight (Mn) of the polyamide of 1.8 to 3.5.

The present disclosure further includes compositions comprising the glass filled polyamides of the present disclosure.

### BRIEF DESCRIPTION OF THE DRAWINGS

The above mentioned and other features of the invention, and the manner of attaining them, will become more apparent and the invention itself will be better understood by reference to the following description of embodiments of the invention taken in conjunction with the accompanying drawings.

FIGS. 1A and 1B shows the tensile strength, in psi, of various un-terminated, mono-terminated, and dual-terminated materials as described in Example 1.

FIG. 2 shows the formic acid viscosity (FAV) versus melt flow index (MFI) trend for glass-filled compounds in accordance with their termination, as described in Example 4.

FIG. 3 shows impact strength and tensile strength versus melt flow index (MFI) for various materials, as described in Example 4.

FIGS. 4A and 4B show formic acid viscosity (FAV) for various un-terminated, mono-terminated, and dual-terminated materials before and after compounding as described in Example 5.

FIG. 5 shows spiral flow (in mm) of an un-terminated polymer and a dual-terminated polymer, as described in Example 6.

FIG. 6A shows a graph of % total termination versus melt viscosity/time slope as described in Example 9.

FIG. 6B shows a histogram of viscosity slope/melt stability as described in Example 9.

Corresponding reference characters indicate corresponding parts throughout the several views. The exemplifications set out herein illustrates various aspects of the invention and such exemplifications are not to be construed as limiting the scope of the invention in any manner.

### DETAILED DESCRIPTION

### 1. Polyamides

The present disclosure relates to low molecular weight terminated polyamides having a narrow molecular weight distribution.

Terminated polyamides may be synthesized as shown below in Equation 1.

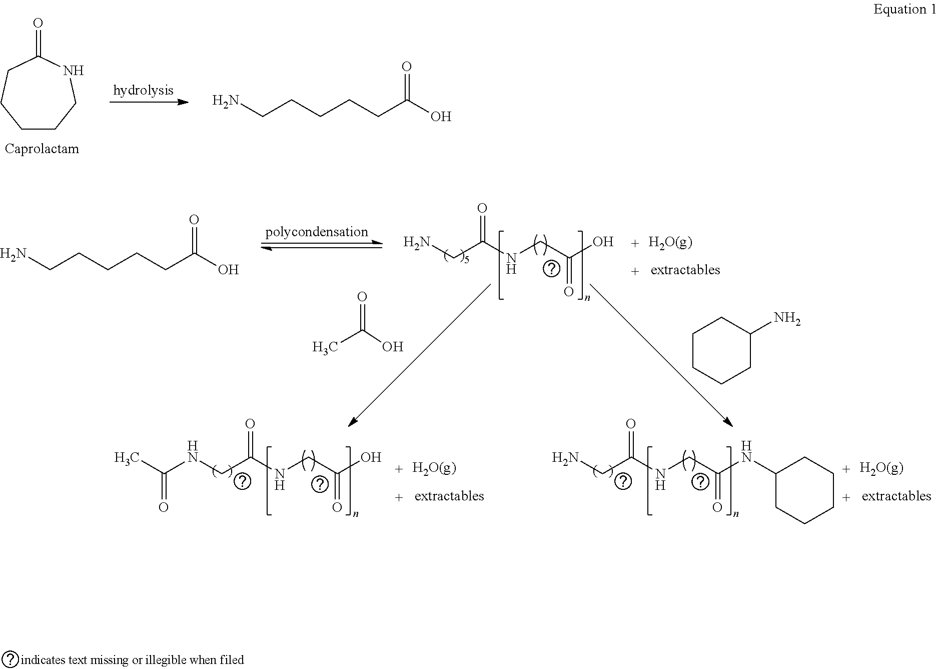

As shown in Equation 1, a lactam, such as caprolactam, may be subjected to hydrolysis to provide a monomer with an amine end group and a carboxyl end group. Monomers may then be subjected to polycondensation to provide a polyamide with an amine end group and a carboxyl end group. The polyamide may then be treated with chain terminators, also referred to herein as terminating agents, to provide a terminated polyamide. For example, the amine end group may be reacted with an acid, such as acetic acid or stearic acid, to block the amine end group and terminate further polymer growth at the amine end group. Likewise, a similar reaction may be performed by treated the carboxyl end group with an amine, such as cyclohexyl amine or stearylamine (octadecylamine), thereby blocking the carboxyl end group and preventing further growth of the polymer from the carboxyl end group.

A mono-terminated polymer refers to a polymer in which only the amine end group or only the carboxyl end group is treated with a chain terminator. A dual-terminated polymer refers to a polymer in which both the amine and carboxyl end groups are treated with chain terminators.

All of the free amine end groups in a given polymer population may be reacted with chain terminators, or a percentage of the amine end groups may be reacted with chain terminators. Examples of amine end group terminating agents include acids such as acetic acid, propionic acid, benzoic acid, stearic acid, and/or terephthalic acid.

The concentration of unterminated (free) amine end groups may be determined as shown below in Equation 2, wherein PTSA signifies para-toluenesulfonic acid.

$$\frac{\begin{matrix}( mL PTSA to titrate sample - \\ mL PTSA to titrate blank ) \times ( Normality of PTSA ) \times 100\end{matrix}}{1 / 2 \times sample weight ( g )} \qquad Equation 2$$

Similarly, all of the free carboxyl end groups in a given polymer population may be reacted with chain terminators, or a percentage of the carboxyl end groups may be reacted with chain terminators. Examples of carboxyl end group terminating agents include monofunctional amides, such as cyclohexylamine, stearylamine, and benzylamine and polyether amines.

The concentration of unterminated (free) carboxyl end groups may be determined as shown below in Equation 3, wherein KOH signifies potassium hydroxide.

$$\frac{\begin{matrix}( mL KOH to titrate sample - \\ mL KOH to titrate blank ) \times ( Normality of KOH ) \times 1000\end{matrix}}{sample weight ( g )} \qquad Equation 3$$

The degree of termination of the amine and carboxyl end groups in a polymer population may also be described by the percentage of termination, also referred to as the degree of termination. The degree of termination of a dual-terminated polyamide can be determined using Equations 4, 5, and 6, below.

$$\% Total termination = [ \frac{\begin{matrix}Equilibrium NH 2 + COOH ends for FAV level - \\ Terminated NH 2 + COOH ends\end{matrix}}{Equilibrium NH 2 + COOH ends for FAV level} ] * 100 \% \qquad Equation 4$$

$$\% NH 2 termination = [ \frac{\begin{matrix}Equilibrium NH 2 ends for FAV level - \\ Terminated NH 2 ends\end{matrix}}{Equilibrium NH 2 ends for FAV level} ] * 100 \% \qquad Equation 5$$

$$\% COOH termination = [ \frac{\begin{matrix}Equilibrium COOH ends for FAV level - \\ Terminated COOH ends\end{matrix}}{Equilibrium COOH ends for FAV level} ] * 100 \% \qquad Equation 6$$

For the polyamides of the present disclosure, the total degree of termination is 30 wt. % or greater, 31 wt. % or greater, about 32 wt. % or greater, about 33 wt. % or greater, about 34 wt. % or greater, about 35 wt. % or greater, about 36 wt. % or greater, about 37 wt. % or greater, about 38 wt. % or greater, about 39 wt. % or greater, about 40 wt. % or greater, about 41 wt. % or greater, about 42 wt. % or greater, about 43 wt. % or less, about 44 wt. % or less, about 45 wt. % or less, about 46 wt. % or less, about 47 wt. % or less, about 48 wt. % or less, about 49 wt. % or less, about 50 wt. % or less, about 51 wt. % or less, about 52 wt. % or less, about 53 wt. % or less, about 54 wt. % or less, about 55 wt. % or less, or any value encompassed by these endpoints.

For the polyamides of the present disclosure, the degree of amine end group termination is about 30 wt. % or greater, about 31 wt. % or greater, about 32 wt. % or greater, about 33 wt. % or greater, about 34 wt. % or greater, about 35 wt. % or greater, 36 wt. % or greater, about 37 wt. % or greater, about 38 wt. % or greater, about 39 wt. % or greater, about 40 wt. % or less, about 41 wt. % or less, about 42 wt. % or less, about 43 wt. % or less, about 44 wt. % or less, about 45 wt. % or less, about 46 wt. % or less, about 47 wt. % or less, about 48 wt. % or less, about 49 wt. % or less, about 50 wt. % or less, or any value encompassed by these endpoints.

For the polyamides of the present disclosure, the degree of termination of the carboxyl end group is about 30 wt. % or greater, about 31 wt. % or greater, about 32 wt. % or greater, about 33 wt. % or greater, about 34 wt. % or greater, about 35 wt. % or greater, 36 wt. % or greater, about 37 wt. % or greater, about 38 wt. % or greater, about 39 wt. % or greater, about 40 wt. % or greater, about 41 wt. % or greater, about 42 wt. % or greater, about 43 wt. % or greater, about 44 wt. % or greater, about 45 wt. % or greater, about 46 wt. % or less, about 47 wt. % or less, about 48 wt. % or less, about 49 wt. % or less, about 50 wt. % or less, about 51 wt. % or less, about 52 wt. % or less, about 53 wt. % or less, about 54 wt. % or less, about 55 wt. % or less, about 56 wt. % or less, about 57 wt. % or less, about 58 wt. % or less, about 59 wt. % or less, about 60 wt. % of less, or any value encompassed by these endpoints.

Polymers may be described according to various statistics referring to their molecular weight. For example, the number average molecular weight (Mn), is calculated according to Equation 7, below, wherein Ni is the number of molecules of mass Mi in the sample.

$$Mn = \frac{\sum Mi Ni}{\sum Ni} \qquad Equation 7$$

The masses of the molecules in the sample may be determined, for example, by gel permeation chromatography (GPC). Mn thus provides the mean molecular weight of the polymers in a sample. The polyamides of the present disclosure have an Mn of about 10,000 Da or greater, about 10,200 Da or greater, about 10,400 Da or greater, about 10,600 Da or greater, about 10,800 DA or greater, about 11,000 Da or greater, about 11,200 Da or greater, about 11,400 Da or greater, about 11,600 Da or greater, about 11,800 Da or greater, about 12,000 Da or greater, about 12,200 Da or greater, about 12,400 Da or greater, about 12,600 Da or greater, about 12,800 Da or greater, about 13,000 Da or greater, about 13,200 Da or greater, about 13,400 Da or greater, about 13,600 Da or greater, about 13,800 Da or greater, about 14,000 Da or greater, about 14,200 Da or greater, about 14,400 Da or greater, about 14,600 Da or greater, about 14,800 Da or greater, about 15,000 Da or less, about 15,200 Da or less, about 15,400 Da or less, about 15,600 Da or less, about 15,800 Da or less, about 16,000 Da or less, about 16,200 Da or less, about 16,400 Da or less, about 16,600 Da or less, about 16,800 Da or less, about 17,000 Da or less, about 17,200 Da or less, about 17,400 Da or less, about 17,600 Da or less, about 17,800 Da or less, about 18,000 Da or less, about 18,200 Da or less, about 18,400 Da or less, about 18,600 Da or less, about 18,800 Da or less, about 19,000 Da or less, about 19,200 Da or less, about 19,400 Da or less, about 19,600 Da or less, about 19,800 Da or less, about 20,000 Da or less, about 20,200 Da or less, about 20,400 Da or less, about 20,600 Da or less, or any value encompassed by these endpoints.

The dual-terminated polymers of the present disclosure may have an Mn of about 11,000 Da or greater, about 11,200 Da or greater, about 11,400 Da or greater, about 11,600 Da or greater, about 11,800 Da or greater, about 12,000 Da or greater, about 12,200 Da or greater, about 12,400 Da or greater, about 12,600 Da or greater, about 12,800 Da or greater, about 13,000 Da or greater, about 13,200 Da or greater, about 13,400 Da or greater, about 13,600 Da or greater, about 13,800 Da or greater, about 14,000 Da or greater, about 14,200 Da or greater, about 14,400 Da or greater, about 14,600 Da or greater, about 14,800 Da or greater, about 15,000 Da or less, about 15,200 Da or less, about 15,400 Da or less, about 15,600 Da or less, about 15,800 Da or less, about 16,000 Da or less, about 16,200 Da or less, about 16,400 Da or less, about 16,600 Da or less, about 16,800 Da or less, about 17,000 Da or less, about 17,200 Da or less, about 17,400 Da or less, about 17,600 Da or less, about 17,800 Da or less, about 18,000 Da or less, or any value encompassed by these endpoints.

The weight average molecular weight (Mw) may also be used to describe a polymer. Mw may be determined by gel permeation chromatography (GPC). Likewise, Mw may be calculated according to Equation 8, below.

$$Mw = \frac{\sum {Mi}^{2} Ni}{\sum Mi Ni} \qquad Equation 8$$

In this equation, larger molecules have a greater influence on the measurement than smaller molecules. The polyamides of the present disclosure have an Mw of about 22,000 Da or greater, about 23,000 Da or greater, about 24,000 or greater, about 25,000 or greater, about 26,000 or greater, about 27,000 or greater, about 28,000 Da or greater, about 29,000 Da or greater, about 30,000 Da or greater, about 31,000 Da or greater, about 32,000 Da or greater, about 33,000 Da or greater, about 35,000 Da or greater, about 36,000 Da or greater, about 37,000 Da or greater, about 38,000 Da or greater, about 39,000 Da or greater, about 40,000 Da or greater, about 41,000 Da or greater, about 42,000 Da or greater, about 43,000 Da or less, about 44,000 Da or less, about 45,000 Da or less, about 46,000 Da or less, about 47,000 Da or less, about 48,000 Da or less, about 49,000 Da or less, about 50,000 Da or less, about 51,000 Da or less, about 52,000 Da or less, about 53,000 Da or less, about 54,000 Da or less, about 55,000 Da or less, about 56,000 Da or less, or any value encompassed by these endpoints.

For dual-terminated polymers of the present disclosure, the Mw may be about 22,000 Da or greater, about 23,000 Da or greater, about 24,000 or greater, about 25,000 or greater, about 26,000 or greater, about 27,000 or greater, about 28,000 Da or less, about 29,000 Da or less, about 30,000 Da or less, about 31,000 Da or less, about 32,000 Da or less, about 33,000 Da or less, about 35,000 Da or less, about 36,000 Da or less, or any value encompassed by these endpoints.

The ratio of Mw to Mn, referred to as the dispersity or polydispersity index provides further information about the polymer. Specifically, the dispersity of a polymer is a measurement of the distribution of molecular weight in a given polymer sample. As a sample approaches uniformity, the dispersity approaches 1. The polyamides of the present disclosure have a dispersity of about 1.8 or greater, about 1.9 or greater, about 2.0 or greater, about 2.1 or greater, about 2.2 or greater, about 2.3 or greater, about 2.4 or greater, about 2.5 or greater, about 2.6 or greater, about 2.7 or greater, about 2.8 or less, about 2.9 or less, about 3.0 or less, about 3.1 or less, about 3.2 or less, about 3.3 or less, about 3.4 or less, about 3.5 or less, or any value encompassed by these endpoints, or any value encompassed by these endpoints.

The dual-terminated polymers of the present disclosure may have a dispersity of about 1.8 or greater, about 1.9 or greater, about 2.0 or greater, about 2.1 or greater, about 2.2 or less, about 2.3 or less, about 2.4 or less, about 2.5 or less, or any value encompassed by these endpoints.

Mn and Mw, as well as dispersity, may be determined by Gas Permeation Chromatography (GPC).

The Z average molar mass, Mz, may also be used to describe a polymer. Mz is calculated according to Equation 9, below.

$$Mz = \frac{\sum {Mi}^{3} Ni}{\sum {Mi}^{2} Ni} \qquad Equation 9$$

The polyamides of the present disclosure have an Mz of about 58,500 Da or greater, about 59,000 Da or greater, about 59,500 Da or greater, about 60,000 Da or greater, about 60,500 Da or greater, about 61,000 Da or greater, about 61,500 Da or greater, about 62,000 Da or greater, about 62,500 Da or greater, about 63,000 Da or less, about 63,500 Da or less, about 64,000 Da or less, about 64,500 Da or less, about 65,000 Da or less, about 65,500 Da or less, about 66,000 Da or less, about 66,500 Da or less, about 67,000 Da or less, about 67,500 Da or less, about 68,000 Da or less, about 68,500 Da or less, or any value encompassed by these endpoints.

The ratio of Mz to Mw may also be used to describe a polymer. The polyamides of the present disclosure may have an Mz to Mw ratio of about 1.60 or greater, about 1.61 or greater, about 1.62 or greater, about 1.63 or less, about 1.64 or less, about 1.65 or less, 1.66 or less, or within any range encompassed by these endpoints.

Polyamides may also be described by their formic acid viscosity (FAV) as determined by the methods described in ASTM D-789. The polyamides of the present disclosure may have an FAV of about 28 or greater, about 29 or greater, about 30 or greater, about 31 or greater, about 32 or greater, about 33 or greater, about 34 or greater, about 35 or greater, about 36 or greater, about 37 or greater, about 38 or greater, about 39 or less, about 40 or less, about 41 or less, about 42 or less, about 43 or less, about 44 or less, about 45 or less, or any value encompassed by these endpoints.

Dual-terminated polymers of the present disclosure may have an FAV of about 28 or greater, about 29 or greater, about 30 or greater, about 31 or greater, about 32 or less, about 33 or less, about 34 or less, about 35 or less, about 36 or less, or any value encompassed by these endpoints.

Polyamides may also be described by their relative viscosity (RV), as determined by the methods described in GB/T 12006.1-2009/ISO 307:2007. The polyamides of the present disclosure may have an RV of about 2.0 or greater, about 2.1 or greater, about 2.2 or greater, about 2.3 or greater, about 2.4 or less, about 2.5 or less, about 2.6 or less, or any value encompassed by these endpoints.

Dual-terminated polymers of the present disclosure may have an RV of about 2.0 or greater, about 2.1 or greater, about 2.2 or less, about 2.3 or less, about 2.4 or less, or any value encompassed by these endpoints.

The polyamides of the present disclosure may have a relatively low extractable content as measured in accordance with ISO 6427. For example, the extractable content may be about 2.0% or less, about 1.5% or less, about 1.0% or less, about 0.5% or less, or about 0.1% or less.

The polyamides of the present disclosure may have a melt flow index (MFI) as determined by the methods described in ASTM D1238 of 20 g/10 min or greater, about 25 g/10 min or greater, about 30 g/10 min or less, about 35 g/10 min or less, about 40 g/10 min or less, or any value encompassed by these values.

The terminated polymers of the present disclosure unexpectedly display low viscosity, even at high molecular weight. It has surprisingly been found that the selection of terminating agents may have an effect on the viscosity of the finished polymer. In particular, dual-terminated polymers appear to provide lower viscosity at higher molecular weight; however, dual-termination alone does not appear to be sufficient to achieve the surprising results of the present disclosure. The dual-terminated polymers with similar molecular weights and percent total termination may still vary in their viscosity in unpredictable ways depending upon the terminating agents used.

For example, as demonstrated further below, the choice of stearic acid versus acetic acid as a terminating agent for the N-terminus of the polymer appears to have little effect, while the choice of cyclohexylamine versus stearylamine (octadecylamine) appears to have significant influence on the viscosity of the polymer.

### 2. Polyamide Synthesis

As shown above in Equation 1, the polyamide may be synthesized by first hydrolyzing a lactam to provide a provide a monomer with an amine end group and a carboxyl end group. The lactam may be β-lactam (2-azetidinone), γ-lactam (2-pyrrolidone), 8-lactone (2-piperidinone), or ϵ-lactam (caprolactam), for example. The hydrolysis may be accomplished under basic conditions or acidic conditions. The hydrolysis may be accomplished in the presence of one more catalysts. The one or more catalyst may be selected from the group consisting of phosphorous acid, alkyl- and aryl-substituted phosphonic acid, hypophosphorous acid, and phosphoric acid.

Hydrolysis may be accomplished at a temperature of about 230° C. or greater, about 235° C. or greater, about 240° C. or greater, about 245° C. or greater, about 250° C. or less, about 255° C. or less, about 260° C. or less, about 265° C. or less, about 270° C. or less, or any value encompassed by these endpoints.

Hydrolysis may be accomplished at a pressure of about 40 psig or greater, about 45 psig or greater, about 50 psig or greater, about 55 psig or less, about 60 psig or less, about 65 psig or less, about 70 psig or less, or within any range encompassing these endpoints.

Following hydrolysis of the lactam, the monomers may be subjected to polycondensation conditions. Polycondensation may be conducted in the presence of one or more catalysts. The one or more catalysts may be selected from the group consisting of phosphorous acid, alkyl- and aryl-substituted phosphonic acid, hypophosphorous acid, and phosphoric acid.

Polycondensation may be accomplished at a temperature of about 230° C. or greater, about 235° C. or greater, about 240° C. or greater, about 245° C. or greater, about 250° C. or less, about 255° C. or less, about 260° C. or less, about 265° C. or less, about 270° C. or less, or any value encompassed by these endpoints.

As shown in Equation 1 above, water is produced in the polycondensation reaction. A water removal process is applied via nitrogen (N₂) injection, and/or a vacuum process may be applied. A pressure or vacuum process is introduced to remove excess water, and in doing so, the equilibrium of the polycondensation reaction is driven to the products side (i.e., the right), resulting in a greater extent of polymerization for the polyamide polymer. Maximum gas addition or vacuum is used to drive, as much as possible, the equilibrium of the polycondensation reaction continuously to the right, thereby achieving polyamide polymers having a greater extent of polymerization.

Polycondensation provides a polyamide with an amine end group and a carboxyl end group. These end groups may be capped with a terminating agent, as discussed above, to stop the polymerization process.

To synthesize the polyamides of the present disclosure, a multi-kettle train may be used. For example, typical polyamide polymers may be synthesized using a multi-kettle train with a run rate of roughly 13,000 lb/hr to 15,000 lb/hr. While not wishing to be bound by theory, it is believed that running the polycondensation step at a lower speed or rate, a lower dispersity or narrower molecular weight distribution in the polyamide polymer may be achieved. For example, the run rate may be about 20% slower, about 25% slower, about 30% slower, about 35% slower, or about 40% slower. For example, the run rate may be about 9000 lb/hr or greater, about 10,000 lb/hr or greater, about 11,000 lb/hr or less, or any value encompassed by these endpoints.

It is believed that the lower run or reaction rate, and the attendant increase in the residence time of the reactants in a given kettle may have been the reason for the perceptibly narrower molecular weight distribution (low dispersity). The molecular weight distribution was confirmed by gel permeation chromatography (GPC). The narrow molecular weight distribution is also demonstrated by the dispersity (Mw/Mn ratio) as described above. These conditions resulted in the synthesis of Polymer #1, a dual-terminated polymer with an average Mw/Mn of 3.45 and FAV of 41-43, and Polymer #2, a dual-terminated polymer with an average Mw/Mn of 3.33 and FAV of 35-37.

### 3. Compound Materials

The polyamides of the present disclosure may be compounded to provide glass-filled materials. Generally, glass-filled compounds are stronger than their corresponding original polymers but have increased melt flow index (MFI) and formic acid viscosity (FAV) in comparison to the original polymer, which may lead to difficulties in processing.

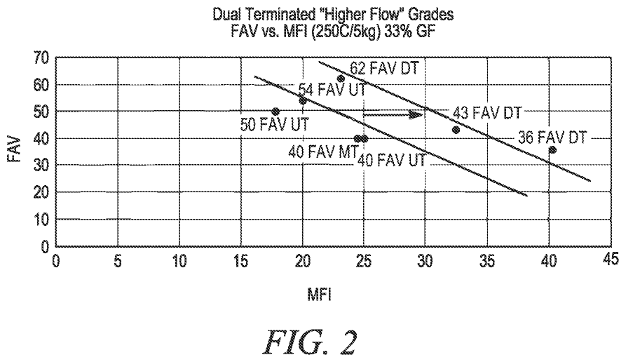

It has surprisingly been found that the polyamides of the present disclosure may be used in compound materials without decreasing their processability. Specifically, an unexpected improvement in melt flow was noted for the dual-terminated glass filled compounds of the present disclosure in comparison to the un-terminated and mono-terminated base resins, as explained further below and shown in FIG. 2. This improved melt flow may improve processability for molding. Improved processability permits the use of the materials in high-aspect ratio molds and may allow for greater molding productivity.

Compound materials of the polyamides of the present disclosure may include glass fibers in an amount of about 30 wt. % or greater, about 31 wt. % or greater, about 32 wt. % or greater, about 33 wt. % or greater, about 34 wt. % or greater, about 35 wt. % or greater, about 36 wt. % or less, about 37 wt. % or less, about 38 wt. % or less, about 39 wt. % or less, about 40 wt. % or less, or any value encompassed by these endpoints.

The melt flow index (MFI) of the glass-filled material may be about 30 g/10 min or greater, about 31 g/10 min or greater, about 32 g/10 min or greater, about 33 g/10 min or greater, about 34 g/10 min or greater, about 35 g/10 min or greater, about 36 g/10 min or greater, about 37 g/10 min or greater, about 38 g/10 min or less, about 39 g/10 min or less, about 40 g/10 min or less, about 41 g/10 min or less, about 42 g/10 min or less, about 43 g/10 min or less, about 44 g/10 min or less, about 45 g/10 min or less, or within any range encompassed by these endpoints, as determined by the methods described in ASTM D1238.

The formic acid viscosity (FAV) of the polyamides of the present disclosure is not expected to increase significantly following compounding, as discussed further below. Specifically, the FAV of the glass-filled compounds of the present disclosure may be about 33 or greater, about 34 or greater, 35 or greater, about 36 or greater, about 37 or greater, about 38 or greater, about 39 or less, about 40 or less, about 41 or less, about 42 or less, about 43 or less, or any value encompassed by these endpoints, as determined by the methods described in ASTM D-789.

An additional unexpected improvement is noted when adding a “high melt flow” dual terminated nylon-6 polyamide as a process enhancing additive for nylon-66 glass-filled compounds, as discussed further below. An un-terminated nylon 6 may be added in an amount of about 10 wt. % or greater, about 12 wt. % or greater, about 15 wt. % or greater, about 17 wt. % or less, about 20 wt. % or less, or within any range encompassing these endpoints. By adding 15 wt. % of an un-terminated nylon 6 (nylon basis w/w) polyamide, the melt flow as measured by melt flow index (MFI) improved by 83%. A dual-terminated nylon 6 may be added in an amount of about 10 wt. % or greater, about 12 wt. % or greater, about 15 wt. % or greater, about 17 wt. % or less, about 20 wt. % or less, or within any range encompassing these endpoints. Improvements in melt flow were also noted when adding 15% of a dual-terminated nylon 6 (nylon basis w/w), wherein the melt flow as measured by melt flow index (MFI) improved by 160%.

This improvement in melt flow for nylon-66 glass-filled compounds may allow for improved surface finish, lower energy requirements during injection molding, the ability to mold the same part using a smaller molding machine, molding of high aspect ratio parts, and molding more parts in multicavity molds.

### EXAMPLES

### Example 1: Measurement of Extractables

Oligomer and TOC (Total Organic Carbon) tests were performed via capillary melt stability tests to determine the amount of caprolactam regeneration after a period of exposure to high temperature. Six samples were tested using capillary viscometry melt stability at 275° C.×30 minutes to determine caprolactam regeneration. Prior to testing, the samples were dried under vacuum at 80° C. for 12 hours. Testing was repeated after the samples absorbed 2000±250 ppm water. Initial results for both polymer 1 and polymer 2 show a similar extractables level for (0.94 wt. % for polymer 1 and 0.59 wt. % for polymer 2). However, following exposure to heat and moisture, polymer 2 displays a slightly level of extractables than polymer 1.

### Example 2: Tensile Strength

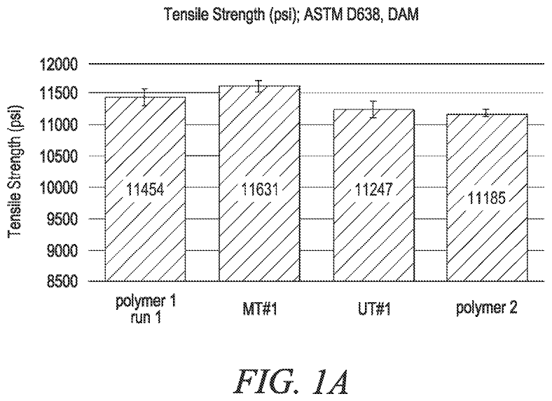

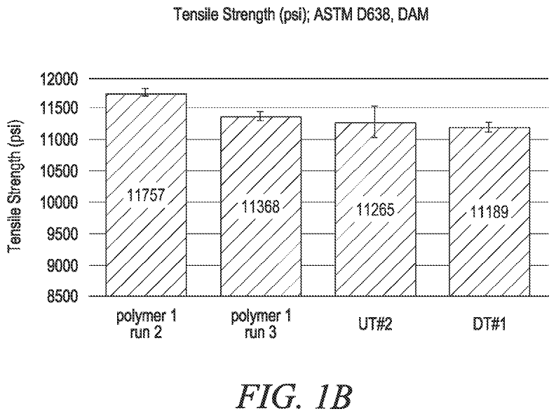

Tensile strength was tested using the methods described in ASTM D-638 for a variety of un-terminated (UT), mono-terminated (MT), and dual-terminated (DT) materials, as shown in FIG. 1. The results show that tensile strength appears to be independent of termination. Furthermore, the materials tested vary in formic acid viscosity (FAV) from 36 (Polymer 2 in FIG. 1) to 60 (DT#1 in FIG. 1); however, tensile strength appears to be independent of FAV as well.

### Example 3: Injection Molding of Glass-Filled Material

The dual terminated nylon-6 resin is compounded with additives which may include process lubricant, color pigments, mineral or glass reinforcement, stabilizers, and other functional modifiers. The compounding is typically conducted by use of a twin-screw co-rotating extruder which is equipped with zone heating, additive feeders and an extrusion die. The compounding extruder is preheated to a temperature above the melt point of the polyamide, and the polyamide resin and desired additives are then fed into the screw. The screw is rotated at a fixed rate to thoroughly mix the components and pump the molten compound or mixture through a die. A molten strand is extruded through the die and dropped into a water bath, where the strand solidifies and cools. The solid strand is the chopped into standard size pellets using a rotating blade pelletizer. The chopped pellets are then dried to a moisture level less than 2000 ppm water prior to subsequent processing. Processing may be accomplished by injection molding, which involves re-melting the compound or mixture in a single screw extruder followed by rapid injection of the melt into a temperature-controlled mold.

### Example 4: Properties of Glass-Filled Compounds

The effect of termination (both mono-and dual-termination) of nylon-6 polyamide was evaluated on glass-filled compounds. Melt flow index (MFI) and mechanical properties were assessed to determine whether there is an unexpected improvement in melt flow in conjunction with retention or improvement of mechanical properties associated with low-viscosity terminated polyamides. The amounts of glass fiber and other components in the formulations are shown below in Table 1, wherein “NT” signifies non-terminated, “MT” signified mono-terminated, and “DT” signifies dual-terminated. “MB” refers to a masterbatch made with 50% carbon black and 50% of the nylon component named in column 1.

TABLE 1

| | Compound | Carbon Black | Glass | Zinc | Total | Nylon | Nylon |
|---|---|---|---|---|---|---|---|
| Nylon | Weight | (50 wt. %) | Fiber | stearate | Nylon | component | component |
| Component | (lbs) | MB (wt. %) | (wt. %) | (wt. %) | (wt. %) | 1 (wt. %) | 2 (wt. %) |
| NT sample #1 | 600 | 2 | 33 | 0.1 | 64.9 | 64.9 | — |
| Polymer 1 | 600 | 2 | 33 | 0.1 | 64.9 | 64.9 | — |
| Polymer 2 | 600 | 2 | 33 | 0.1 | 64.9 | 64.9 | — |
| MT sample #1 | 600 | 2 | 33 | 0.1 | 64.9 | 64.9 | — |
| DT sample #1 | 600 | 2 | 33 | 0.1 | 64.9 | 64.9 | — |
| UT sample #2 | 600 | 2 | 33 | 0.1 | 64.9 | 64.9 | — |
| UT sample #3 | 600 | 2 | 33 | 0.1 | 64.9 | 64.9 | — |
| Nylon 2.4 RV | 600 | 2 | 33 | 0.1 | 64.9 | 64.9 | — |
| Nylon 2.7 RV | 600 | 2 | 33 | 0.1 | 64.9 | 64.9 | — |
| Polymer 2 + | 600 | 2 | 35 | 0.1 | 64.9 | 32.45 | 32.45 |
| UT sample #2 | | | | | | | |
| (50/50) | | | | | | | |
| Nylon-66 + | 60 | 2 | 35 | 0.1 | 62.9 | 53.47 | 9.44 |
| 15% Polymer 1 | | | | | | | |
| Nylon-66 + 15% | 60 | 2 | 35 | 0.1 | 62.9 | 53.47 | 9.44 |
| UT sample #1 | | | | | | | |
| Nylon-66 | 60 | 2 | 35 | 0.1 | 62.9 | 62.9 | — |

The FAV values of melt stability samples were measured using standard ASTM D-789 formic acid viscosity testing method. The RV values were determined as shown below in Equation 10.

### Equation 10:

RV(96% H₂SO₄ASTM D-789)=0.651×FAV^{0.357}

Table 2 below lists the results obtained for both FAV and RV.

TABLE 2

| Material | Termination | FAV | RV |
|---|---|---|---|
| UT sample #1 | Un-terminated | 40 | 2.4 |
| Polymer 1 | Dual-terminated | 43 | 2.5 |
| Polymer 2 | Dual-terminated | 36 | 2.3 |
| MT sample #1 | Mono-terminated | 40 | 2.4 |
| DT sample #1 | Dual-terminated | 62 | 2.8 |
| UT sample #2 | Un-terminated | 50 | 2.6 |
| UT sample #3 | Un-terminated | 54 | 2.7 |
| Nylon 2.4 RV | Mono-terminated | 39 | 2.4 |
| Nylon 2.7 RV | Mono-terminated | 52 | 2.7 |
| Nylon-66 | Un-terminated | 55 | 2.7 |

FIG. 2 shows the formic acid viscosity (FAV) versus melt flow index (MFI) trend for 33% glass-filled compounds in accordance with their termination, with un-terminated polyamides designated as “UT”, mono-terminated polyamides designated as “MT”, and dual-terminated polyamides designated as “DT”.

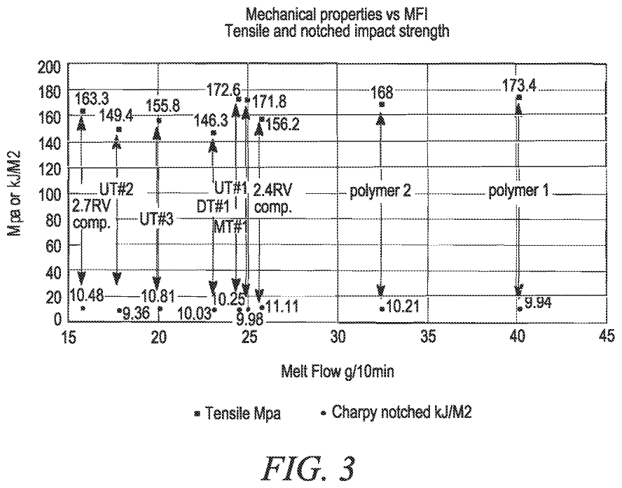

FIG. 3 shows that mechanical properties, such as tensile strength and notched impact strength, remain relatively constant despite changes in termination, with unterminated polyamides designated as “UT”, mono-terminated polyamides designated as “MT”, and dual-terminated polymers as “DT”. Two further nylon samples are included for comparison, one with relative viscosity (RV) of 2.7 designated as “2.7RV comp.”, and one with RV of 2.4 designated as “2.4RV comp.”.

The same trend is observed for other mechanical properties, such as tensile elongation, tensile modulus, charpy un-notched, flex modulus, and flex strength, using the standard methods shown in Table 3. The results of the tests are shown in Tables 4 and 5.

TABLE 3

| Method | Standard |
|---|---|
| Ash | ISO 3451 |
| Melt Flow Index (MFI) | ASTM 1238 |
| Tensile, Elongation, Tensile Mod | ISO 527-2 |
| Charpy, un-notched and notched | ISO 179 |
| Flexural Modulus and Strength | ISO 178 |
| (Flex mod and Flex str) | |
| Specific Gravity (SPG) | ISO 1183 |
| Heat Deflection Temperature (HDT) | ISO 75-2 |
| Melting Point by DSC (DSC) | ISO 11357 |

TABLE 4

| | | UT | | | MT | DT | UT | UT |
|---|---|---|---|---|---|---|---|---|
| | | sample | Polymer | Polymer | sample | sample | sample | sample |
| Property | Unit | #1 | 1 | 2 | #1 | #2 | #2 | #3 |
| Ash | % | 32.44 | 33.59 | 32.73 | 33.59 | 32.99 | 32.82 | 32.48 |
| Melt Flow | g/10 min | 24.98 | 32.46 | 40.18 | 24.48 | 23.08 | 17.82 | 20.08 |
| Transfer P | PSI | 638 | 576 | 560 | 621 | 687 | 616 | 748 |
| Tensile | MPa | 171.8 | 168 | 173.4 | 172.6 | 146.3 | 149.4 | 155.8 |
| Elongation | % | 2.21 | 3.8 | 1.95 | 2.08 | 1.65 | 1.59 | 2.1 |
| Tensile mod | MPa | 12903 | 13215 | 12944 | 14194 | 11679 | 11276 | 13470 |
| Charpy | kJ/m² | 76.34 | 78.71 | 69.7 | 78.14 | 66.68 | 63.75 | 69.45 |
| un-notched | | | | | | | | |
| Charpy | kJ/m² | 9.98 | 10.21 | 9.94 | 10.22 | 10.03 | 9.36 | 10.81 |
| notched | | | | | | | | |
| Flex mod | kJ/m² | 9132 | 10332 | 9931 | 11354 | 10066 | 11072 | 10900 |
| Flex str. | kJ/m² | 235 | 258 | 251 | 272 | 250 | 267 | 267 |
| SPG | — | 1.395 | 1.397 | 1.394 | 1.41 | 1.401 | 1.399 | 1.393 |
| HDT 1.8 | C. | 216.8 | 220.1 | 216.3 | 218 | 216.6 | 217.4 | 206.8 |
| MPa | | | | | | | | |
| DSC | C. | 222 | 223 | 223 | 222 | 220 | 223 | 221 |

TABLE 5

| | | | | Polymer | | | |
|---|---|---|---|---|---|---|---|
| | | | | 2 + UT | | PA66 + | |
| | | Nylon | Nylon | sample #2 | PA66 + 15% | 15% UT | |
| Property | Unit | 2.4 RV | 2.7 RV | (50/50) | Polymer 1 | sample #1 | PA66 |
| Ash | % | 33.01 | 33.02 | 32.57 | 34.65 | 34.93 | 35.31 |
| Melt Flow | g/10 min | 25.74 | 15.82 | 19.18 | 47.98 | 33.7 | 18.44 |
| Transfer P | PSI | 635 | 793 | 838 | 819 | 960 | 635 |
| Tensile | MPa | 156.2 | 163.3 | 165.3 | 173.9 | 162.9 | 181.4 |
| Elongation | % | 2.21 | 1.93 | 2.21 | 1.68 | 1.45 | 1.93 |
| Tensile mod | MPa | 13626 | 14247 | 13119 | 15840 | 17418 | 15507 |
| Charpy | kJ/m² | 74.67 | 69.28 | 83.76 | 72.49 | 76.96 | 86.8 |
| un-notched | | | | | | | |
| Charpy | kJ/m² | 11.11 | 10.48 | 9.63 | 8.67 | 8.62 | 10.84 |
| notched | | | | | | | |
| Flex mod | kJ/m² | 10900 | 10385 | 11114 | 11971 | 12396 | 11399 |
| Flex str. | kJ/m² | 274 | 262 | 270 | 296 | 291 | 284 |
| SPG | — | 1.4 | 1.405 | 1.4 | 1.42 | 1.43 | 1.42 |
| HDT 1.8 | C. | 218.3 | 215.2 | 218.6 | 231.5 | 239.1 | 259.2 |
| MPa | | | | | | | |
| DSC | C. | 223 | 221 | 222 | 260 | 261 | 261.6 |

### Example 5: FAV of Non-Compounded and Compounded Materials

Formic acid viscosity (FAV) was measured for various un-terminated, mono-terminated, and dual-terminated materials before compounding and after compounding. Table 6 below shows the change in FAV.

TABLE 6

| | | FAV | FAV | |
|---|---|---|---|---|
| Material | Termination | Before | After | % Increase |
| UT sample #1 | Un-terminated | 40.2 | 50.92 | 26.7 |
| UT sample #2 | Un-terminated | 50.3 | 57.73 | 14.8 |
| MT sample #1 | Mono-terminated | 44.7 | 50.04 | 11.9 |
| Polymer 1 | Dual-terminated | 43.7 | 43.6 | −0.2 |
| Polymer 2 | Dual-terminated | 36.7 | 39.62 | 8.0 |
| DT sample #1 | Dual-terminated | 64.2 | 63.05 | −1.8 |

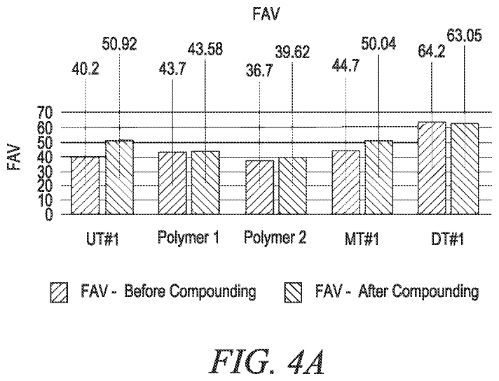

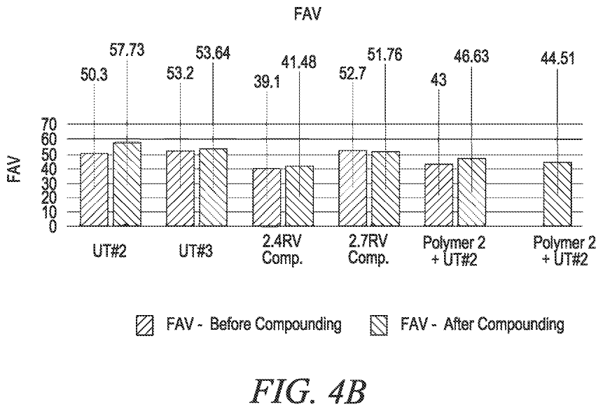

While un-terminated and mono-terminated polyamides show significant changes in FAV following compounding, the dual-terminated polyamides of the present disclosure (Polymer 1 and Polymer 2) show very little change in FAV. This data is presented in graphic form in FIG. 4.

### Example 6: Spiral Flow Improvement in Non-Compounded Materials

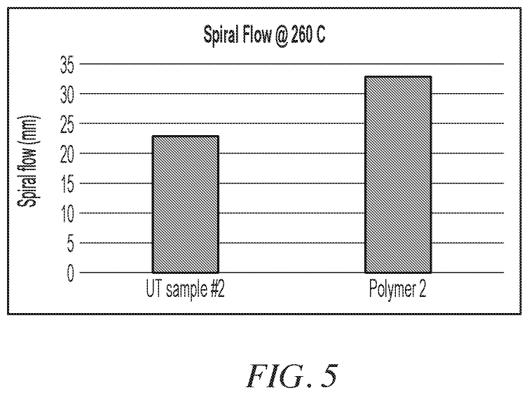

To determine whether terminated material flows better in a mold during processing than a counterpart, non-terminated material, two samples were compared: UT #2 was chosen as a representative un-terminated material of like Mw and Mn, and Polymer 2 was selected as the dual-terminated material. Spiral flow was measured according to ASTM D3123 to demonstrate the material flow length in the mold during the injection molding process. As shown in FIG. 5, the dual-terminated polymer (Polymer 2) had a longer flow path (33 mm) than the un-terminated polymer (UT #2), which had a 23 mm flow path under the same conditions. These results suggest that the terminated polymers of the present disclosure demonstrate better, or higher flow during injection molding than un-terminated polymers.

### Example 7: Melt Flow Improvement in Glass-Filled Compounds

The melt flow index (MFI) of glass-filled nylon-66 was tested both with and without additional polyamides using the methods described in ASTM D1238. When 15% of a low FAV dual-terminated polyamide (such as Polymer 2) was added to the glass-filled nylon-66, melt flow increased considerably, as shown below in Table 7.

TABLE 7

| 35% Glass | 100% | 85% Nylon-66/ | 85% Nylon-66/ |
|---|---|---|---|
| Fiber Compound | Nylon-66 | 15% UT#1 | 15% Polymer 2 |
| Run 1 MFI (g/10 min) | 18.44 | 33.70 | 47.98 |
| % Improvement over | n/a | 83% | 160% |
| Nylon-66 | | | |
| Run 2 MFI (g/10 min) | 35.8 | 40.2 | 43.1 |
| % Improvement over | n/a | 12% | 20% |
| Nylon-66 | | | |

In contrast, the improvement in melt flow index (MFI) was much less when an un-terminated polyamide of similar FAV (40 FAV), UT #1 (un-terminated sample #1) was added, as shown in Table 7.

### Example 8: Typical Methods of Mono-Terminated and Dual-Terminated polyamide Syntheses on 12-liter Scale

The following are typical methods used to synthesize mono-terminated and dual terminated polyamides on a 12-liter scale. Persons skilled in the art will be able to adjust reaction conditions and reagents based on the desired end products.

Caprolactam (5584 g) and acetic acid (13.5 g) are charged into a 12 L reaction vessel. Deionized water (102 g) is then added. After pressure testing the reactor with nitrogen, the contents of the reactor are slowly heated to 230° C. to initiate the reaction. The reactor is maintained at 230° C. for 60 minutes, after which the reactor is heated to 250° C. over twenty minutes while purging with nitrogen. After 3 hours reaction time, the molten polymer is then extruded by gravity into a single strand, quenched with ice water, and pelletized. After leaching and drying the pellets the solution viscosity in formic acid is determined according to method of ASTM D789. The end group analysis is also performed on the dried polyamide.

A somewhat modified method can be used to make a dual-terminated polyamide. Caprolactam (5513 g) and cyclohexylamine (CHA) (21.3 g) and stearic acid (63.8 g) are charged into a 12 L reaction vessel. Deionized water (101 g) is added. After pressure testing the reactor with nitrogen, the contents of the reactor are slowly heated to 230° C. to initiate the reaction. The reactor is then maintained at 230° C. for 60 minutes, followed by heating to a temperature of 250° C. through a ramp over a 20-minute time period to start polymerization. After 7 hours of reaction, the molten polymer is then extruded by gravity into a single strand, quenched with ice water, and pelletized. After leaching and drying the pellets the solution viscosity in formic acid is determined according to method of ASTM D789. The end group analysis is also performed on the dried polyamide.

### Example 9: Melt Stability of Mono- and Dual-Terminated versus Un-Terminated Polymers

Measuring polyamide melt viscosity by use of a capillary rheometer at constant shear rate is one method to assess increases in polyamide viscosity with time. The term melt stability is used to address the propensity of the polyamide melt to resist increases in polyamide viscosity during melt compounding or during a capillary rheometer measurement. The slope of melt viscosity with time may be used as a quantitative measurement of melt stability with lower values indicative of better melt stability.

Samples of polyamide 6 (PA 6) were prepared from caprolactam. Table 8 below shows whether the sample was un-terminated (UT), mono-terminated (MT), or dual-terminated (DT), as well as the level of termination and terminating agent used, with the different levels of termination affecting the total percent termination. The amount of acid terminator and amine terminator is noted as meq/kg charged to the reactor.

TABLE 8

| Sample | | Acid | | Amine | |
|---|---|---|---|---|---|
| # | Termination | Terminator | meq/kg | terminator | meq/kg |
| DT #2 | Dual- | Stearic acid | 40.0 | Cyclohexylamine | 30.6 |
| | terminated | | | | |
| DT #3 | Dual- | Stearic acid | 40.0 | Cyclohexylamine | 30.6 |
| | terminated | | | | |
| DT #4 | Dual- | Stearic acid | 40.0 | Cyclohexylamine | 30.6 |
| | terminated | | | | |
| DT #5 | Dual- | Stearic acid | 40.0 | Cyclohexylamine | 37.9 |
| | terminated | | | | |
| DT #6 | Dual- | Acetic acid | 40.0 | Stearylamine | 37.9 |
| | terminated | | | | |
| DT #7 | Dual- | Stearic acid | 40 | Stearylamine | 37.9 |
| | terminated | | | | |
| MT #2 | Mono- | Stearic acid | 40.0 | None | 0 |
| | terminated | | | | |
| MT#3 | Mono- | Stearic acid | 40.1 | None | 0 |
| | terminated | | | | |
| MT #4 | Mono- | Acetic acid | 40.2 | None | 0 |
| | terminated | | | | |
| DT #8 | Dual- | Acetic acid | 33.3 | Cyclohexylamine | 37.9 |
| | terminated | | | | |
| UT #4 | Un- | None | 0 | None | 0 |
| | terminated | | | | |
| UT #5 | Un- | None | 0 | None | 0 |
| | terminated | | | | |
| DT #9 | Dual- | Stearic acid | 40.0 | Cyclohexylamine | 30.6 |
| | terminated | | | | |
| DT #10 | Dual- | Stearic acid | 40.0 | Cyclohexylamine | 30.6 |
| | terminated | | | | |
| MT #6 | Mono- | Stearic acid | 33.3 | None | 0 |
| | terminated | | | | |
| MT #7 | Mono- | Acetic acid | 33.3 | None | 0 |
| | terminated | | | | |
| DT #11 | Dual- | Acetic acid | 33.3 | Cyclohexylamine | 37.9 |
| | terminated | | | | |

Next, crystallization temperature (T_{c}) and melting point (Tₘ) were determined for the samples via differential scanning calorimetry (DSC). The results are shown below in Table 9, along with FAV, RV, and Mn. The amine end groups are shown in meq/kg in Table 9.

TABLE 9

| Sample | | | | | | | NH₂ |
|---|---|---|---|---|---|---|---|
| # | T_{c} ° C. | Tₘ ° C. | FAV | RV | Mn | Mw | meq/kg |
| DT #2 | 183.0 | 221.6 | 29.67 | 2.18 | 12,152 | 24,304 | 38.7 |
| DT #3 | 182.6 | 221.6 | 30.54 | 2.21 | 12,403 | 24,805 | 40.0 |
| DT #4 | 184.5 | 221.6 | 33.59 | 2.28 | 13,250 | 26,499 | 30.0 |
| DT #5 | 184.9 | 222.0 | 34.09 | 2.29 | 13,384 | 26,768 | 31.4 |
| DT #6 | 184.9 | 222.1 | 34.48 | 2.30 | 13,488 | 26,976 | 34.5 |
| DT #7 | 185.5 | 222.1 | 35.00 | 2.32 | 13,626 | 27,251 | 33.7 |
| MT #2 | 183.1 | 221.9 | 41.39 | 2.46 | 15,223 | 30,446 | 23.2 |
| MT#3 | 185.4 | 221.8 | 34.66 | 2.31 | 13,536 | 27,071 | 32.5 |
| MT #4 | 185.3 | 221.6 | 36.54 | 2.35 | 14,026 | 28,052 | 30.2 |
| DT #8 | 175 | 223 | 36.7 | 2.36 | 14,067 | 28,134 | 49.8 |
| UT #4 | 176.8 | 221.6 | 40.31 | 2.44 | 14,964 | 29,929 | 66.8 |
| UT #5 | 172.00 | 222.30 | 50.12 | 2.63 | 17,174 | 34,348 | 19.1 |
| DT #9 | 181.2 | 221.4 | 60.6 | 2.82 | 19,247 | | 19.5 |
| DT #10 | 181.0 | 221.3 | 57.7 | 2.77 | 18,698 | | 16.7 |
| MT #6 | 182.2 | 221.7 | 61.28 | 2.83 | 19,373 | | 15.6 |
| MT #7 | 183.7 | 221.3 | 66.79 | 2.92 | 20,362 | | 21.5 |
| DT #11 | 175.0 | 223.0 | 63.06 | 2.86 | 19,699 | | 19.1 |

Table 10 shows termination percentages of termination N-terminus (% NH₂) as determined according to Equation 5, the C-terminus (% COOH) as determined according to Equation 6, and the percent of total termination (% TT) as determined according to Equation 4, as well as zero shear viscosity at 260° C., melt flow rate at 235° C. for 1.21, and the spiral flow.

TABLE 10

| | | | | Zero | Melt | Spiral |
|---|---|---|---|---|---|---|
| Sample | % | % | % | shear | flow rate | flow |
| # | NH₂ | COOH | TT | viscosity | (g/10 min) | (mm) |
| DT #2 | 53.0% | 46.5% | 49.7% | 64 | 50.5 | — |
| DT #3 | 50.4% | 43.8% | 47.1% | 58 | 48.9 | — |
| DT #4 | 60.2% | 53.2% | 56.7% | 92 | 38.7 | 41 |
| DT #5 | 58.0% | 68.9% | 63.4% | 88 | 37.3 | 51 |
| DT #6 | 53.5% | 65.5% | 59.5% | 80 | 39.1 | 52 |
| DT #7 | 54.1% | 66.0% | 60.0% | 93 | 42.2 | 58 |
| MT #2 | 64.7% | 0.0% | 32.4% | 144 | 23.2 | — |
| MT#3 | 56.0% | 0.0% | 28.0% | 91 | 32.9 | 46 |
| MT #4 | 57.6% | 0.0% | 28.8% | 130 | 30.5 | 48 |
| DT #8 | 29.9% | 48.1% | 39.0% | 130 | 29.9 | 45 |
| UT #4 | 0.0% | 0.0% | 0.0% | 233 | 18.4 | 41 |
| UT #5 | 0.0% | 0.0% | 0.0% | 376 | 10.4 | 23 |
| DT #9 | 63.3% | 52.3% | 57.8% | 172 | 11.0 | — |
| DT #10 | 63.5% | 53.7% | 58.6% | 218 | 11.1 | — |
| MT #6 | 67.6% | 0.0% | 33.8% | 341 | 10.2 | — |
| MT #7 | 68.2% | 0.0% | 34.1% | 386 | 8.2 | — |
| DT #11 | 57.6% | 60.6% | 59.1% | 313 | 9.1 | — |

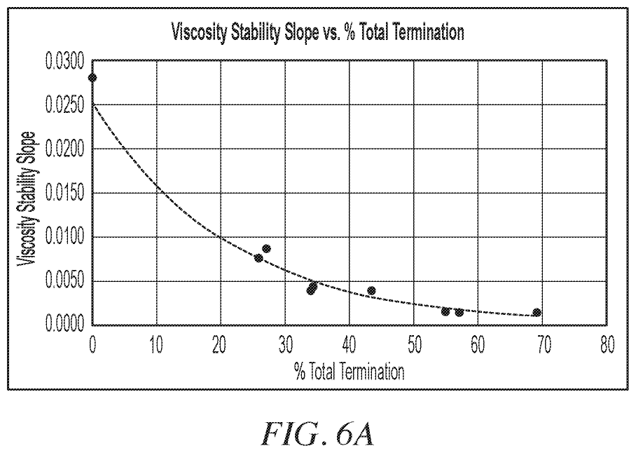

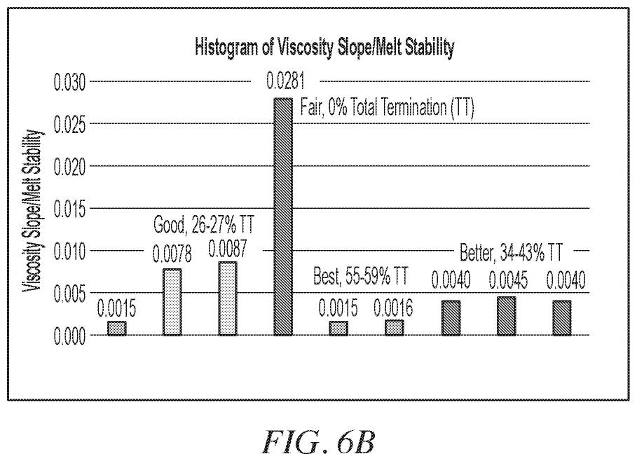

FIG. 6B shows a histogram of viscosity/time slope values for the PA6 examples is shown where values are grouped into levels of melt stability (good, better, best, etc.) along with level of % total termination for the samples. It may be noted that some samples may have improved melt flow (as measured by Melt Flow Index, MFI at 235° C., 1.2 kg) as compared to samples with similar relative solution viscosities but lower % Total Termination and higher viscosity/time slopes.

The calculated percent of amine end groups (% NH₂), carboxylic acid end groups (% COOH), and total termination (% TT) are shown in Table 10, along with the viscosity slope and melt flow index. The percent total termination is rated as fair (0%), good (26-27%), better (34-43%) and best (55-59%).

TABLE 10

| | | Viscosity/ | Relative | | | | |
|---|---|---|---|---|---|---|---|
| Sample | % | Time slope | melt | % | % | | |
| # | TT | at 260° C. | stability | NH₂ | COOH | FAV | MFI |
| DT #5 | 57 | 0.0015 | Best | 54.0 | 60.4 | 34.09 | 37.3 |
| MT #3 | 26 | 0.0078 | Good | 52.0 | 0.0 | 34.66 | 32.9 |
| MT #4 | 27 | 0.0087 | Good | 54.3 | 0.0 | 36.54 | 30.5 |
| UT #4 | 0 | 0.0281 | Fair | 0.0 | 0.0 | 40.31 | — |
| DT #11 | 69 | 0.0015 | Best | 58.2 | 80.0 | 63.06 | — |
| DT #6 | 55 | 0.0016 | Best | 49.1 | 60.7 | 34.48 | 39.1 |
| MT #6 | 34 | 0.0040 | Better | 68.0 | 0.0 | 61.28 | — |
| MT#7 | 34 | 0.0045 | Better | 68.9 | 0.0 | 66.79 | — |
| DT #8 | 43 | 0.0040 | Better | 24.5 | 62.5 | 36.7 | 40 |

Based on these results, it appears that PA6 samples with higher % Total Termination may be better than PA6 with lower % Total Termination or 0% Total Termination at reducing the melt viscosity increase during melt residence time (in capillary rheometry or other melt processes). This may result in better flow during processing steps such as injection molding and improved capability to mold thin, long and/or high aspect ratio complex parts. It can also be concluded that the % Total Termination that drives the melt stability and improved flow behaviors as opposed to differences between mono-and dual-termination.

### ASPECTS

Aspect 1 is a terminated polyamide, comprising: a weight average molecular weight (Mw) from 22,000 Da to 56,000 Da; and a formic acid viscosity (FAV) of less than 45.

Aspect 2 is the terminated polyamide of Aspect 1, comprising: a weight average molecular weight (Mw) from 22,000 Da to 36,000 Da; and a formic acid viscosity (FAV) of less than 45.

Aspect 3 is the terminated polyamide of either Aspect 1 or Aspect 2, having carboxyl end groups, and wherein a percentage of carboxyl end group termination is from 30 wt. % to 60 wt. %.

Aspect 4 is the terminated polyamide of any one of Aspects 1 to 3, having amine end groups, and wherein a percentage of amine end group termination is from 30 wt. % to 50 wt. %.

Aspect 5 is the terminated polyamide of any of Aspects 1-4, wherein the terminated polyamide has a relative viscosity (RV) of 2.0 to 2.6.

Aspect 6 is the terminated polyamide of any of Aspects 1-5, wherein the terminated polyamide has a melt flow index (MFI) from 20 g/10 min to 40 g/10 min.

Aspect 7 is the terminated polyamide of any of Aspects 1-6, wherein the ratio of the weight average molecular weight (Mw) of the terminated polyamide to the number average molecular weight (Mn) of the terminated polyamide is from 1.8 to 3.5

Aspect 8 is the terminated polyamide of any of Aspects 1-7, further comprising glass fibers in an amount from 30 wt. % to 40 wt. %, based on the combined weight of the terminated polyamide and glass fibers.

Aspect 9 is a process of synthesizing a terminated polyamide, comprising: hydrolyzing a lactam to provide monomers having an amine end group and a carboxyl end group; polycondensing the monomers at a temperature of 230°° C. to 270° C. to provide polyamide polymers having an amine end group and a carboxyl group; and terminating the polyamide by reaction with at least one chain terminator to provide a terminated polyamide with a weight average molecular weight (Mw) of 22,000 Da to 56,000 Da and a formic acid viscosity (FAV) of less than 45.

Aspect 10 is the process of Aspect 9, wherein the terminated polyamide has a weight average molecular weight of 22,000 Da to 36,000 Da and a formic acid viscosity (FAV) of less than 45.

Aspect 11 is the process of either Aspect 9 or Aspect 10, wherein the chain terminators are selected from the group consisting of cyclohexylamine, stearylamine, stearic acid, and acetic acid.

Aspect 12 is the process of any one of Aspects 9-11, wherein the percentage of carboxyl end group termination of the terminated polyamide is from 30 wt. to 60 wt. %.

Aspect 13 is the process of any of Aspects 9-12, wherein the percentage of amine end group termination of the terminated polyamide is from 30 wt. % to 50 wt. %.

Aspect 14 is the process of any of Aspects 9-13, further comprising the addition of glass fibers in an amount from 30 wt. % to 40 wt. %, based on a combined weight of the polyamide and glass fibers to provide a glass filled polyamide.

Aspect 15 is a polyamide composition comprising: the glass filled polyamide of Aspect 14 in an amount from 80 wt. % to 90 wt. %, based on a total weight of the composition; and a second polyamide in an amount from 10 wt. % to 20 wt. %, based on a total weight of the composition.

Aspect 16 is the composition of Aspect 15, wherein the second polyamide is selected from the group consisting of unterminated polyamides and dual terminated polyamides.

Aspect 17 is the composition of either Aspect 15 or Aspect 16, wherein the melt flow index (MFI) of the composition is from 30 g/10 min to 45 g/10 min.

Aspect 18 is the composition of any of Aspects 15-17, wherein the ratio of the weight average molecular weight (Mw) of the terminated polyamide to the number average molecular weight (Mn) of the terminated polyamide is 1.8 to 3.5.

While this invention has been described as relative to exemplary designs, the present invention may be further modified within the spirit and scope of this disclosure. Further this application is intended to cover such departures from the present disclosure as come within known or customary practice in the art to which this invention pertains.

1. A terminated polyamide, comprising:
a weight average molecular weight (Mw) from 22,000 Da to 56,000 Da; and
a formic acid viscosity (FAV) of less than 45.

2. The terminated polyamide of claim 1, comprising:
a weight average molecular weight (Mw) from 22,000 Da to 36,000 Da; and
a formic acid viscosity (FAV) of less than 45.

3. The terminated polyamide of claim 1, having carboxyl end groups, and wherein a percentage of carboxyl end group termination is from 30 wt. % to 60 wt. %.

4. The terminated polyamide of claim 1, having amine end groups, and wherein a percentage of amine end group termination is from 30 wt. % to 50 wt. %.

5. The terminated polyamide of claim 1, wherein the terminated polyamide has a relative viscosity (RV) of 2.0 to 2.6.

6. The terminated polyamide of claim 1, wherein the terminated polyamide has a melt flow index (MFI) from 20 g/10 min to 40 g/10 min.

7. The terminated polyamide of claim 1, wherein the ratio of the weight average molecular weight (Mw) of the terminated polyamide to the number average molecular weight (Mn) of the terminated polyamide is from 1.8 to 3.5.

8. The terminated polyamide of claim 1, further comprising glass fibers in an amount from 30 wt. % to 40 wt. %, based on the combined weight of the terminated polyamide and glass fibers.

9. A process of synthesizing a terminated polyamide, comprising:
hydrolyzing a lactam to provide monomers having an amine end group and a carboxyl end group;
polycondensing the monomers at a temperature of 230° C. to 270° C. to provide polyamide polymers having an amine end group and a carboxyl group; and
terminating the polyamide by reaction with at least one chain terminator to provide a terminated polyamide with a weight average molecular weight (Mw) of 22,000 Da to 56,000 Da and a formic acid viscosity (FAV) of less than 45.

10. The process of claim 9, wherein the terminated polyamide has a weight average molecular weight of 22,000 Da to 36,000 Da and a formic acid viscosity (FAV) of less than 45.

11. The process of claim 9, wherein the chain terminators are selected from the group consisting of cyclohexylamine, stearylamine, stearic acid, and acetic acid.

12. The process of claim 9, wherein the percentage of carboxyl end group termination of the terminated polyamide is from 30 wt. to 60 wt. %.

13. The process of claim 9, wherein the percentage of amine end group termination of the terminated polyamide is from 30 wt. % to 50 wt. %.

14. The process of claim 9, further comprising the addition of glass fibers in an amount from 30 wt. % to 40 wt. %, based on a combined weight of the polyamide and glass fibers to provide a glass filled polyamide.

15. A polyamide composition comprising:
the glass filled polyamide of claim 14 in an amount from 80 wt. % to 90 wt. %, based on a total weight of the composition; and
a second polyamide in an amount from 10 wt. % to 20 wt. %, based on a total weight of the composition.

16. The composition of claim 15, wherein the second polyamide is selected from the group consisting of unterminated polyamides and dual terminated polyamides.

17. The composition of claim 15, wherein the melt flow index (MFI) of the composition is from 30 g/10 min to 45 g/10 min.

18. The composition of claim 15, wherein the ratio of the weight average molecular weight (Mw) of the terminated polyamide to the number average molecular weight (Mn) of the terminated polyamide is 1.8 to 3.5.
